(19) United States
(12) Patent Application Publication
(10) Pub. No.: US 2021/0262121 A1
(43) Pub. Date: Aug. 26, 2021

(54) METHOD OF MXENE FIBER AND MXENE FIBER MANUFACTURED THEREFROM

(71) Applicants: KOREA ADVANCED INSTITUTE OF SCIENCE AND TECHNOLOGY, Daejeon (KR); KOREA INSTITUTE OF SCIENCE AND TECHNOLOGY, Seoul (KR)

(72) Inventors: SangOuk KIM, Daejeon (KR); Taeyeong YUN, Daejeon (KR); Jin Gu KIM, Daejeon (KR); Gang San LEE, Daejeon (KR); Chong Min KOO, Seoul (KR); Hye Rim KIM, Seoul (KR); Seon Joon KIM, Seoul (KR); Soon Man HONG, Seoul (KR); Seung Sang HWANG, Seoul (KR); Kyung Youl BAEK, Seoul (KR); Sangho CHO, Seoul (KR)

(21) Appl. No.: 17/172,736

(22) Filed: Feb. 10, 2021

(30) Foreign Application Priority Data
Feb. 10, 2020 (KR) 10-2020-0015422

(51) Int. Cl. D01D 5/06; D01F 6/74; D01F 9/08; D01D 5/38

(52) U.S. Cl. CPC D01D 5/06; D01F 6/74; D10B 2101/14; D01D 5/38; D10B 2401/16; D01F 9/08

(57) ABSTRACT

Provided are a method of manufacturing MXene fibers and MXene fibers manufactured therefrom, wherein the method includes a) preparing a dispersion including MXenes; and b) spinning the dispersion in a coagulation solution to obtain MXene fibers.

### CROSS-REFERENCE TO RELATED APPLICATIONS

This application claims priority under 35 U.S.C. § 119 to Korean Patent Application No. 10-2020-0015422, filed on Feb. 10, 2020, in the Korean Intellectual Property Office, the disclosure of which is incorporated herein by reference in its entirety.

### TECHNICAL FIELD

The following disclosure relates to a method of manufacturing MXene fibers and MXene fibers manufactured therefrom.

### BACKGROUND

As a single atomic layer material having a honeycomb structure, which is composed of carbon atoms, graphene has gained a great deal of worldwide attention due to its excellent physical properties. As an explosion of interest has been focused on research on such graphene, interests in two-dimensional materials similar to graphene have increased recently.

As one of such two-dimensional materials, MXene is a group of the two-dimensional materials obtained from a MAX phase having a three-dimensional crystal structure, which is composed of an M layer, an A layer, and an X layer. Here, M is a transition metal, A is an element of Group 13 or 14, and X is carbon and/or nitrogen. Such a MAX phase is a crystalline phase in which A, which is a metal element different from MX or M having ceramic characteristics, is combined with MX or M, and thus has excellent properties such as electrical conductivity, oxidation resistance, machinability, and the like. In theory, several hundreds or thousands of MAX phases may exist, but it is known that approximately 300 MAX phases are synthesized so far.

The MAX phase is a three-dimensional material, but has a structure in which layered phases of a transition metal carbide linked with each other are stacked via a weak chemical or physical bond between an element A and a transition metal M unlike graphite, a metal dichalcogenide material, or the like. Therefore, MXenes obtained from the MAX phase also have a drawback in that it is difficult to realize a highly compact shape of fibers, and the like due to its weak bond between the layers.

Furthermore, the MXenes have a lamellar structure, and thus has a drawback in that it is difficult to manufacture MXene fibers due to the weak interaction between the MXene layers as described above because the MXenes have a small average size of 1 μm or less.

As a result, in the prior art, only when a solution obtained by mixing a carbon-based compound (such as graphene and the like) or a MXene (such as a polymer and the like) is spun and manufactured into composite fibers, the composite fibers may be obtained by fiberization. However, when the composite fibers are subjected to such a mixing process, the composite fibers have a drawback in that it is difficult to obtain fibers capable of maintaining high intrinsic properties of the MXenes. Therefore, research on manufacture of the MXene fibers is in an insufficient situation.

Therefore, there is a need for development of a method of manufacturing MXene fibers capable of maintaining the intrinsic properties (such as mechanical strength, electrical conductivity, and the like) of the MXenes and having excellent characteristics.

### SUMMARY

An embodiment of the present invention is directed to providing MXene fibers obtained by spinning a dispersion including MXenes.

Another embodiment of the present invention is directed to providing a method of manufacturing MXene fibers whose excellent electrical conductivity and mechanical properties are realized.

Still another embodiment of the present invention is directed to providing high-density MXene fibers whose uniform and compact cross section is realized, and a method of manufacturing the same.

In a general aspect, a method of manufacturing MXene fibers is provided. The method of manufacturing MXene fibers includes: a) preparing a dispersion including MXenes; and b) spinning the dispersion in a coagulation solution to obtain MXene fibers.

The coagulation solution according to one aspect of the present invention may include a low-molecular-weight binder including a functional group.

The MXene fibers according to one aspect of the present invention may be linked via any one or more attraction forces selected from electrostatic interaction and hydrophobic interaction as the low-molecular-weight binder including the functional group is inserted between MXene layers.

The low-molecular-weight binder including the functional group according to one aspect of the present invention may be an amine-based compound or an imine-based compound.

The diamine-based compound according to one aspect of the present invention may be an aliphatic diamine.

After the step b) compound according to one aspect of the present invention, the method may further include heat-treating the MXene fibers at 100 to 500° C.

The dispersion according to one aspect of the present invention may include 5 to 30% by weight of the MXenes, based on the total weight of the dispersion.

The dispersion according to one aspect of the present invention may further include a phenol-based amine.

A weight ratio of the MXenes and the phenol-based amine included in the dispersion according to one aspect of the present invention may be in a range of 1:0.001 to 0.5.

In another general aspect, MXene fibers have a round, oval, or flat cross-sectional shape.

The MXene fibers according to one aspect of the present invention may be linked via any one or more attraction forces selected from electrostatic interaction and hydrophobic interaction as a low-molecular-weight binder including a functional group is inserted between MXene layers.

The MXene fibers according to one aspect of the present invention may include 1.5 to 10 moles of carbon atoms, 0.5 to 4 moles of oxygen atoms, and 0.01 to 1 mole of nitrogen atoms, based on 1 mole of a transition metal derived from the MXenes.

The low-molecular-weight binder including the functional group according to one aspect of the present invention may be an amine-based compound or an imine-based compound.

The diamine-based compound according to one aspect of the present invention may be an aliphatic diamine.

A weight ratio of the MXenes and the low-molecular-weight binder including the functional group included in the MXene fibers according to one aspect of the present invention may be in a range of 1:0.01 to 0.5.

The MXene fibers according to one aspect of the present invention may have an average diameter of 10 to 500 μm.

The MXene fibers according to one aspect of the present invention may have an electrical conductivity of 800 S/cm or more.

The MXenes according to one aspect of the present invention may be complexed with polydopamine.

The polydopamine according to one aspect of the present invention may be obtained by polymerizing dopamine through an effect of charge transfer with the MXenes.

In still another general aspect, MXene fibers include 0.1 to 1 mole of carbon atoms, 0.1 to 1 mole of oxygen atoms, and 0.01 to 0.1 moles of nitrogen atoms, based on 1 mole of a transition metal, and have an electrical conductivity of 1,050 S/cm or more.

The MXene fibers according to one aspect of the present invention may be manufactured by heat-treating the MXene fibers which are linked with the low-molecular-weight binder via any one or more attraction forces selected from electrostatic interaction and hydrophobic interaction as a low-molecular-weight binder including a functional group is inserted between MXene layers.

The heat treatment according to one aspect of the present invention may be performed at 100 to 500° C.

The MXene fibers according to one aspect of the present invention may satisfy the following Expression 1:

$$\frac{{D}_{1}}{{D}_{0}} < 1.0 \qquad [ Expression 1 ]$$

(wherein D₀ represents a d-spacing (nm) of (002) plane calculated from an X-ray diffraction pattern of the MXene fibers before heat treatment using a Cu Kα radiation, and D₁ represents a d-spacing (nm) of (002) plane calculated from an X-ray diffraction pattern of the MXene fibers after the heat treatment using a Cu Kα radiation).

### BRIEF DESCRIPTION OF THE DRAWINGS

FIGS. 1A-1D are images of observing a cross section of a MXene fiber according to one embodiment of the present invention using a scanning electron microscope. FIGS. 1A and 1B are images of enlarged cross sections of MXene fibers of Example 1 with magnifications of 600 times and 3,500 times, respectively, and FIGS. 1C and 1D are images of enlarged cross sections of MXene fibers of Example 2 with magnifications of 1,000 times and 9,000 times, respectively.

FIGS. 2A-2B are images of observing a method of manufacturing MXene fibers according to one embodiment of the present invention. FIG. 2A is an image of spinning the MXene fibers in a coagulation solution, and FIG. 2B is an image of drying the spun MXene fibers.

FIGS. 3A-3B are images of a cross section of a MXene fiber according to one embodiment of the present invention using a scanning electron microscope. FIGS. 3A and 3B are images of enlarged cross sections of MXene fibers of Example 1, which is manufactured, respectively, using oval and rectangular spinning nozzles, with a magnification of 700 times.

FIG. 4 shows the results of analyzing compositions of the MXene fibers according to one embodiment of the present invention by means of X-ray diffraction analysis (XRD).

FIG. 5 shows the results of analyzing properties of the MXene fibers according to one embodiment of the present invention by means of X-ray photoelectron spectroscopy (XPS).

FIGS. 6A-6D are images of observing a cross section of a MXene fiber according to one embodiment of the present invention using a scanning electron microscope. FIG. 6A and FIG. 6B are images of enlarged cross sections of MXene fibers of Example 9 with magnifications of 400 times and 2,500 times, respectively, and FIG. 6C and FIG. 6D are images of enlarged cross sections of MXene fibers of Example 10 with magnifications of 400 times and 2,000 times, respectively.

### DETAILED DESCRIPTION OF EMBODIMENTS

Hereinafter, a method of manufacturing MXene fibers according to the present invention and MXene fibers manufactured therefrom will be described in further detail with reference to examples thereof. However, it should be understood that the present invention may be embodied in various forms, and that the following examples are illustrative only to describe the present invention in more detail, but are not intended to limit the scope of the present invention.

Also, unless otherwise defined, all of the technical and scientific terms used herein have the same meaning as commonly understood by one of ordinary skill in the art to which the present invention pertains. The terms used in the detailed description of this application are given only to effectively describe certain examples, but are not intended to limit the present invention.

MXenes have a drawback in that it is difficult to manufacture the MXenes into fibers in a densely compact shape due to the weak interaction between layers. Due to this reason, composite fibers were manufactured by spinning a solution obtained by mixing MXenes such as a carbon-based compound, a polymer, or the like in the prior art. However, the composite fibers have a limitation in improving properties because the composite fibers have significantly inferior properties, compared to the excellent intrinsic properties of the MXenes. Accordingly, there is a need for development of MXene fibers capable of maintaining or improving the excellent intrinsic properties of the MXenes, and a method of manufacturing the same.

To solve the above problems, the present invention provides a method of manufacturing MXene fibers and MXene fibers manufactured therefrom, as follows.

Specifically, the method of manufacturing MXene fibers according to the present invention includes: a) preparing a dispersion including MXenes; and b) spinning the dispersion in a coagulation solution to obtain MXene fibers.

In this case, the coagulation solution may include a low-molecular-weight binder including a functional group.

In the low-molecular-weight binder including the functional group, the functional group may be a nucleophilic substituent. For example, the nucleophilic substituent may be an amine group, an imine group, or an azide group, and the amine group may be a primary, secondary, or tertiary amine.

The low-molecular-weight binder including the functional group may have a molecular weight of 10 to 600, specifically 30 to 300, and more specifically 50 to 100.

According to one preferred aspect, the low-molecular-weight binder may be a compound including an amine group, which has a molecular weight of 30 to 300. According to one more preferred aspect, the low-molecular-weight binder may be a diamine-based compound having a molecular weight of 50 to 100.

The method of manufacturing MXene fibers according to the present invention may provide high-density MXene fibers by spinning a dispersion including MXenes. Furthermore, the MXene fibers may have a high density by spinning a dispersion consisting only of the MXenes without including a heterogeneous material such as carbon-based compound, a polymer, or the like. Therefore, the MXene fibers whose excellent mechanical properties and electrical conductivity are realized may be provided.

As such, to spin the dispersion including MXenes to provide high-density MXene fibers in the present invention is to spin the dispersion in a coagulation solution including a low-molecular-weight binder, which includes a nucleophilic substituent, to obtain fibers. On the other hand, when the dispersion is spun in a coagulation solution containing a binder, which does not include a nucleophilic substituent, for example, a coagulation solution including an alcohol-based compound, it is difficult to fiberize the dispersion due to the weak interaction between MXene layers, and, although fibers are manufactured, low-density fibers having a coarse cross section are manufactured. Therefore, the MXene fibers have significantly inferior mechanical properties and electrical conductivity.

According to one aspect of the present invention, the dispersion including MXenes is a dispersion in which MXenes are dispersed in a solvent. Preferably, the dispersion may be a dispersion that is composed only of the MXenes without including a heterogeneous material such as a carbon-based compound, a polymer, or the like.

Preferably, the dispersion including MXenes may be a dispersion in which the MXenes are dispersed in a polar solvent. As a specific example, the polar solvent may include any one or a mixed solvent of two or more selected from water such as distilled water, purified water, and the like; alcohol-based solvents such as methanol, ethanol, methoxyethanol, propanol, isopropanol, butanol, isobutanol, and the like; ketone-based solvents such as acetone, methyl ethyl ketone, methyl isobutyl ketone, and the like; ester-based solvents such as ethyl acetate, butyl acetate, 3-methoxy-3-methyl butyl acetate, and the like; amine-based solvents such as dimethyl formamide, methyl pyrrolidone, dimethyl acetamide, and the like; and ether-based solvents such as tetrahydrofuran, 2-methyltetrahydrofuran, dimethyl ether, dibutyl ether, and the like. Preferably, the dispersion may be a dispersion in which the MXenes are dispersed in water such as purified water, distilled water, or the like, which facilitates the dispersion of the MXenes.

According to one aspect of the present invention, the dispersion may include 5 to 30% by weight of the MXenes, based on the total weight of the dispersion. Preferably, the dispersion may include 5 to 20% by weight of the MXenes.

When the MXenes are included within this range, high-density MXene fibers having a dense and compact structure may be provided, and thus may exhibit excellent mechanical properties and electrical conductivity.

According to one aspect of the present invention, the dispersion including MXenes may further include a phenol-based amine.

In this case, the phenol-based amine may include a compound represented by the following Formula 1:

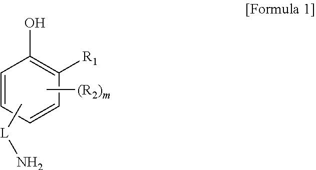

wherein,

R¹ is any one selected from hydrogen, hydroxyl, carboxylic acid, and a salt thereof;

R² is each independently any one or a combination of two or more selected from the group consisting of a (C1-C10) alkyl, a (C1-C10) alkenyl, a (C3-C20) cycloalkyl, a (C3-C20) heterocycloalkyl, a (C6-C20) aryl, a (C3-C20) heteroaryl, a nitro, a cyano, —C(═O) R¹¹, and —C(═O) OR¹²;

R¹¹ and R¹² are each independently any one or a combination of two or more selected from the group consisting of hydrogen, a (C1-C10) alkyl, a (C3-C20) cycloalkyl, a (C3-C20) heterocycloalkyl, a (C6-C20) aryl, and a (C3-C20) heteroaryl;

L is a divalent linking group;

m is an integer ranging from 1 to 3;

it may be linked to an adjacent substituent to form a ring when m is 2 or more; and

the alkyl, the alkenyl, the cycloalkyl, the heterocycloalkyl, the aryl, or the heteroaryl of R², R¹¹, and R¹² may be each independently substituted with any one or more substituents selected from the group consisting of hydroxy, carboxylic acid, (C1-C10) alkoxy, (C1-C10) alkylcarbonyl, a halogen, an amine, a cyano, a nitro, and a salt thereof.

R¹ of the compound represented by Formula 1 is hydrogen or hydroxy; L is a (C1-C10) alkylene or a (C1-C10) alkenylene, —CH₂— of the alkylene or the alkenylene may be replaced with any one selected from the group consisting of —N(R¹³)—, —C(═O) NH—, —C(═O)O—, and —O—; R¹³ may be any one selected from the group consisting of hydrogen, a (C1-C10) alkyl, and an amino(C1-C10) alkyl; and the alkylene and the alkenylene of L may be further replaced with any one or more substituents selected from the group consisting of a halogen, hydroxy, an amine, carboxylic acid, a (C1-C10) alkoxy, a (C1-C10) alkylcarbonyl, and a salt thereof.

Specifically, the compound represented by Formula 1 may include a dopamine-based monomer. More specifically, the compound may include one or more selected from dopamine, dopamine-quinone, alpha-methyldopamine, norepinephrine, epinephrine, dopamine hydrochloride, alpha-methyldopa, droxidopa, indolamine, serotonin, and 5-hydroxy dopamine.

According to one embodiment of the present invention, a weight ratio of the MXenes and the phenol-based amine included in the dispersion may be in a range of 1:0.001 to 0.5, specifically in a range of 1:0.005 to 0.25, and more specifically in a range of 0.01 to 0.15.

Particularly, the dispersion including MXenes, which further contains the phenol-based amine, may be stirred for 0.5 to 10 hours, specifically stirred for 0.5 to 8 hours, and more specifically stirred for 0.5 to 4 hours. As one example, in the case of the phenol-based amine including the dopamine-based monomer, dopamine may be polymerized through a charge transfer with the MXenes included in the dispersion while stirring the dispersion. In this case, surfaces of the MXenes may be coated with the polymerized polydopamine. The polymerization may be performed while oxidizing dopamine through a charge transfer in which electrons move from dopamine to the MXene in an acidic or neutral aqueous solution. The entire surfaces of the MXenes may be coated with the polydopamine. Of course, a portion of the surfaces of the MXenes may be coated with the polydopamine. As such, the MXenes may be complexed with the polydopamine, and the MXenes complexed with the polydopamine may be spun in the coagulation solution as previously described above because the polydopamine may serve as an adhesive between the MXenes. Therefore, MXene fibers having a dense and compact structure and having a more pleated cross-sectional shape as compared to those known in the prior art may be provided as the obtained MXene fibers. For the purpose of this effect, a weight ratio of the MXenes and the phenol-based amine included in the dispersion preferably falls within this range.

According to one aspect of the present invention, the MXenes may be manufactured by means of chemical exfoliation of a precursor “MAX phase.”

According to one aspect of the present invention, the MAX phase is a three-dimensional crystal structure material that is composed of an M layer, an A layer, and an X layer. Here, M is a transition metal, A is an element of Group 13 or 14, and X is carbon, nitrogen, or a combination thereof. As one specific example, the MAX phase is a crystal phase having a MAX structure in which at least 10 or more monolayers are stacked. In this case, atomic layers corresponding to Group 13 or 14 are disposed between two-dimensional transition metal carbide layers or transition metal nitride layers, and the two-dimensional transition metal carbide layers or transition metal nitride layers are linked with each other by the transition-metal atomic layers. That is, the MAX phase has a structure in which the atomic layers corresponding to Group 13 or 14 are alternately disposed on the transition metal carbide layer or the transition metal nitride layer to form one crystal.

The chemical exfoliation used to exfoliate the MAX phase into MXenes may be specifically performed by introducing a MAX phase in a strong acid solution including a fluorine-containing compound. As one specific example, the fluorine-containing compound may include any one or a mixture of two or more selected from lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium bifluoride (NH₄HF₂), ammonium hexafluoroaluminate ((NH₄)₃AlF₆), and the like. For example, the strong acid solution used in the reaction may include any one or a mixture of two or more selected from hydrogen fluoride (HF), hydrochloric acid (HCl), sulfuric acid (HSO₄) aqueous solutions, and the like.

According to one aspect of the present invention, the chemical exfoliation may be performed for 1 to 48 hours, preferably 10 to 40 hours under a condition of 20 to 100° C., preferably 20 to 60° C., but the present invention is not limited thereto.

As the MXenes are subjected to such chemical exfoliation, the MXenes specifically has a structure of transition metal carbide or transition metal nitride because an A layer is etched so that the MXenes are composed of a transition metal layer and a carbon layer; or a transition metal layer and a nitrogen layer.

That is, the MXenes may be an inorganic compound in a two-dimensional shape, which is represented by the formula Mₙ₊₁Xₙ. In this case, M represents a transition metal, particularly titanium (Ti), zirconium (Zr), hafnium (Hf), vanadium (V), chromium (Cr), manganese (Mn), scandium (Sc), molybdenum (Mo), niobium (Nb), tantalum (Ta), or a combination thereof, X represents carbon (C), nitrogen (N), or a combination thereof, and n is a natural number ranging from 1 to 3.

According to one aspect of the present invention, the MXenes may include one or two or more selected from Ti₂C, (Ti_{0.5}, Nb_{0.5})₂C, V₂C, Nb₂C, Mo₂C, Ti₃C₂, Ti₃CN, Zr₃C₂, Hf₃C₂, Ti₄N₃, Nb₄C₃, Ta₄C₃, Mo₂TiC₂, Cr₂TiC₂, and Mo₂Ti₂C₃.

According to one aspect of the present invention, the step b) is to spin the dispersion in a coagulation solution including a low-molecular-weight binder including a functional group. Specifically, the spinning may be wet spinning. For example, the wet spinning is a method of applying a pressure to the dispersion to spin the dispersion in a coagulation solution in which fibers are coagulated through a small spinning spinneret, thereby forming fibers as the dispersion is solidified and precipitated due to the diffusion of a solvent into the coagulation solution.

According to one aspect of the present invention, a spinning temperature of the dispersion may be in a range of 10 to 100° C., preferably in a range of 20 to 80° C., but the present invention is not limited thereto. Also, a pressure during spinning of the spinning solution may be in a range of 1 to 50 psi, but the present invention is not limited thereto. A temperature of the coagulation solution may be in a range of 0 to 50° C., preferably in a range of 0 to 40° C. in order to coagulate the fibers to be spun, but the present invention is not limited thereto.

A cross-sectional shape of the MXene fibers according to one aspect of the present invention may be easily adjusted according to the shape of the spinning spinneret. Particularly, it was difficult to manufacture spun fibers using only a two-dimensional material such as conventional MXenes, and it was also difficult to adjust the cross-sectional shape of the fiber. However, a method of manufacturing the MXene fibers according to one aspect of the present invention has an advantage in that the dispersion may be manufactured into MXene fibers with cross sections having various shapes according to the shape of the spinning spinneret. That is, when the shape of the spinning spinneret is in a round, oval, or rectangular shape, the shape of MXene fibers to be manufactured may have a round, oval, or rectangular shape, respectively. A shape of the fibers is not limited to certain shapes, and a cross-sectional shape of the fibers may be easily changed into a desired shape according to the shape of the spinning spinneret.

According to one aspect of the present invention, a diameter of the spinning spinneret may, for example, be in a range of 50 to 1,000 μm, preferably in a range of 100 to 1,000 μm, and more preferably in a range of 150 to 800 μm during the spinning the spinning, but the present invention is not limited thereto.

The MXene fiber according to one aspect of the present invention may have a varying average diameter according to the diameter of the spinning spinneret. For example, the average diameter of the MXene fibers may be in a range of 10 to 500 μm. Preferably, the average diameter of the MXene fibers may be in a range of 10 to 300 μm, and more preferably in a range of 10 to 250 μm, but the present invention is not limited thereto. As such, the MXene fibers having a wide range of average diameters, which span from fine fibers to thick fibers, may be manufactured without any limitation to the diameters or shapes thereof, and thus may be widely applied to various fields.

In the step b) according to the present invention, the dispersion may be spun in a coagulation solution including a low-molecular-weight binder including a functional group, thereby allowing the low-molecular-weight binder including the functional group to penetrate between MXene layers to induce formation of fibers. Specifically, the dispersion may be spun in the coagulation solution including the low-molecular-weight binder including the functional group, thereby allowing the low-molecular-weight binder including the functional group to be inserted between the MXene layers to induce the formation of fibers which are linked via any one or more attraction forces selected from electrostatic interaction and hydrophobic interaction. Although it was difficult to manufacture fibers composed only of the conventional MXenes, such a bond may be induced to provide high-density MXene fibers in which MXenes are formed in a dense and compact manner, and thus superior mechanical properties and electrical conductivity may be realized.

According to one aspect of the present invention, the low-molecular-weight binder including the functional group may be a low-molecular-weight binder including a nucleophilic substituent, specifically an amine-based compound, an imine-based compound, or an azide-based compound. More specifically, the low-molecular-weight binder including the functional group may be an aliphatic diamine, further specifically a C1-C30 aliphatic diamine, and preferably a C1-C10 aliphatic diamine. For example, the low-molecular-weight binder including the functional group may be any one or a mixture of two or more selected from ethylenediamine, 1,3-trimethylenediamine, 1,4-tetramethylenediamine, 1,5-pentamethylenediamine, 1,6-hexamethylenediamine, 1,8-octamethylenediamine, 2-methyl-1,5-pentanediamine, 3-methyl-1,5-pentanediamine, 2,2,4-trimethyl-1,6-hexanediamine, 2,4,4-trimethyl-1,6-hexanediamine, 2-methyl-1,8-octanediamine, 5-methyl-1,9-nonanediamine, and the like. Most preferably, the low-molecular-weight binder including the functional group may be a C1-C5 aliphatic diamine, for example, any one or a mixture of two or more selected from ethylenediamine, 1,3-trimethylenediamine, 1,4-tetramethylenediamine, 1,5-pentamethylenediamine, and the like.

According to one aspect of the present invention, the coagulation solution including the low-molecular-weight binder including the functional group may include the low-molecular-weight binder including the functional group at a concentration of 0.01 to 5.0 moles. Preferably, the low-molecular-weight binder including the functional group may be included at a concentration of 0.1 to 2.0 moles. When the low-molecular-weight binder including the functional group is included within this range, any one or more attraction forces selected from electrostatic interaction and hydrophobic interaction may be strongly induced between the MXene layers, and high-density MXene fibers having a more compact structure may be provided.

According to one aspect of the present invention, a step of drying the MXene fibers obtained in the step b) may be further performed. Specifically, the drying may be performed at room temperature for 10 minutes to 5 hours. Preferably, the MXene fibers may be dried for 30 minutes to 2 hours, and more preferably 30 minutes to 1 hour, but the present invention is not limited thereto. Water or the solvent remaining in the fiber may be removed by means of the drying. The drying method is not particularly limited, and the MXene fibers may be dried using drying methods generally used in the art.

According to one aspect of the present invention, after the step b), a step of winding the MXene fibers at a winding speed of 0.1 to 1,000 m/min may be further performed. Preferably, the MXene fibers may be wound at a winding speed of 0.1 to 500 m/min, and more preferably 0.1 to 100 m/min, but the present invention is not limited thereto. Uniformity of the MXene fibers manufactured by selecting such a winding speed may be regulated, and crystallinity in an axial direction of the fibers may be improved.

According to one aspect of the present invention, after the step b), the method may further include heat-treating the MXene fibers at 100 to 500° C. Preferably, the heat treatment may be performed at 350 to 500° C. Also, the heat treatment may be performed for 30 minutes to 5 hours, preferably 30 minutes to 2 hours. Because the heat treatment is a process different from the drying, the heat treatment may be further performed to remove moisture and a residual oxygen-functional group present on surfaces of the MXene fibers, resulting in further improved stability. Also, fibers having a more compact structure may be induced, and their mechanical properties and electrical conductivity may be remarkably improved.

According to one aspect of the present invention, the heat treatment may be performed under an atmosphere of inert gas. The inert gas may include any one or two or more selected from nitrogen, argon, neon, helium, and the like, but the present invention is not limited thereto.

Also, the present invention provides MXene fibers having a round, oval, or flat cross-sectional shape. In this case, the MXene fibers may be manufactured by the method of manufacturing MXene fibers as described above.

According to one aspect of the present invention, the MXene fibers may be linked via any one or more attraction forces selected from electrostatic interaction and hydrophobic interaction as a low-molecular-weight binder including a functional group is inserted between MXene layers.

The inside of the MXene fibers may be composed of compact tissues. Specifically, when a compact structure in which inner defects of the fibers are minimized is formed, the mechanical properties and electrical conductivity may be remarkably improved, compared to the conventional MXene fibers. That is, the mechanical properties and electrical conductivity of the MXene fibers according to the present invention, which have not been achieved for the existing MXene fibers, may be realized, and thus availability of the MXene fibers may be widened. Furthermore, the present invention has technical characteristics in that a novel manufacturing process capable of spinning fibers made only of MXenes as a two-dimensional material is established, and MXene fibers which do not include a carbon-based compound and a polymer are provided.

Up to now, the fibers including MXenes are fibers that are provided in a mixed state including a carbon-based compound or a polymer, and thus have a limitation in improving the intrinsic properties of the MXenes because the intrinsic properties of the MXenes are inhibited accordingly. On the other hand, according to the present invention, the high-density MXene fibers in which MXenes are uniformly and densely concentrated may be provided, and excellent mechanical properties and electrical conductivity of the MXene fibers may be achieved. Such MXene fibers may be obtained by the aforementioned manufacturing method of the present invention.

According to one aspect of the present invention, the MXene fibers may include 1.5 to 10 moles of carbon atoms, 0.5 to 4 moles of oxygen atoms, and 0.01 to 1 mole of nitrogen atoms, based on one mole of a transition metal derived from the MXenes. Specifically, the MXene fibers may include 2.0 to 5 moles of carbon atoms, 0.8 to 1.5 moles of oxygen atoms, and 0.1 to 0.8 moles of nitrogen atoms, based on one mole of the transition metal. In this case, the carbon and nitrogen atoms may be derived from the MXenes and the low-molecular-weight binder including the functional group.

According to one aspect of the present invention, a weight ratio of the MXenes and the low-molecular-weight binder including the functional group included in the MXene fibers may be in a range of 1:0.01 to 0.50, preferably in a range of 1:0.01 to 0.30. When the weight ratio is satisfied as described above, the MXenes and the low-molecular-weight binder including the functional group are linked to interact with each other, which makes it possible to fiberize the MXenes, a process in which it was difficult to perform single fiberization. Furthermore, the significantly improved mechanical properties and electrical conductivity may be ensured without any degradation of the intrinsic properties of the MXenes.

According to one aspect of the present invention, the MXene fibers may have a tensile strength of 60 MPa or more. Specifically, the MXene fibers may have a tensile strength of 60 to 200 MPa, preferably a tensile strength of 80 to 200 MPa, and more preferably a tensile strength of 100 to 200 MPa. When the excellent tensile strength is realized as described above, deformation and damage of the fibers themselves may be prevented, and the fibers may have long-term durability as well.

According to one aspect of the present invention, the MXene fibers may have an electrical conductivity of 800 S/cm or more, specifically an electrical conductivity of 800 to 2,000 S/cm. When the excellent electrical conductivity is realized as described above, the MXene fibers may be widely applied to various electrochemical devices requiring the excellent electrical characteristics.

According to one aspect of the present invention, the MXenes of the MXene fibers may be complexed with polydopamine. The type of complexation may be a type in which the entire surfaces of MXenes are coated with polydopamine. Of course, the type of complexation may be a type in which a portion of the surfaces of MXenes is coated with the polydopamine. In this case, a thickness of the coated polydopamine may be in a range of 0.05 to 50 nm, specifically in a range of 0.1 to 20 nm, and more specifically in a range of 1 to 10 nm. The MXenes complexed by coating with the polydopamine within this thickness range should be provided to the MXene fibers, but it is desirable in that the MXene fibers having a dense and compact structure and having a more pleated cross-sectional shape as compared to those known in the prior art may be provided, and the significantly improved mechanical properties and electrical conductivity of the MXene fibers may be ensured as well.

According to one aspect of the present invention, the polydopamine may be obtained by polymerizing dopamine through an effect of charge transfer with the MXenes. As the dopamine is polymerized through the effect of charge transfer, the polydopamine may serve as an adhesive between the MXenes to provide MXenes complexed with the polydopamine so that the MXenes complexed with the polydopamine have a more pleated cross-sectional shape as compared to those known in the prior art.

Also, the present invention provides the MXene fibers manufactured by heat-treating the MXene fibers as described above. In the following description, as a low-molecular-weight binder including a functional group may be inserted between the aforementioned MXene layers, the MXene fibers linked via any one or more attraction forces selected from electrostatic interaction and hydrophobic interaction are defined as MXene fibers (I), and the MXene fibers manufactured by heat-treating the MXene fibers (I) are defined as MXene fibers (II).

According to one aspect of the present invention, the heat treatment may be performed at 100 to 500° C., specifically 350 to 500° C. In this case, the heat treatment may be performed for 30 minutes to 5 hours, specifically 30 minutes to 2 hours, but the present invention is not limited thereto. Also, the heat treatment may be performed under an atmosphere of inert gas. The inert gas may include any one or two or more selected from nitrogen, argon, neon, helium, and the like, but the present invention is not limited thereto.

When the MXene fibers (II) are subjected to heat-treatment, the MXene fibers (II) may have a more compact structure. Due to such a compact structure, the mechanical properties (such as tensile strength) of the MXene fibers (II) may be improved, and the electrical conductivity of the MXene fibers (II) may also be significantly improved. Also, an oxygen-functional group present on surfaces of the MXene fibers (I) may also be removed during the heat treatment. In particular, the oxygen-functional group including a hydroxyl group (—OH) may be removed. It is desirable in that the removal of such an oxygen-functional group may result in an increase in charge carrier mobility or charge carrier density of the MXene fibers, thereby improving the electrical properties of the MXenes.

According to one aspect of the present invention, the MXene fibers (II) may include 0.1 to 1 mole of carbon atoms, 0.1 to 1 mole of oxygen atoms, and 0.01 to 0.1 moles of nitrogen atoms, based on one mole of the transition metal. Specifically, the MXene fibers (II) may include 0.2 to 0.6 moles of carbon atoms, 0.2 to 0.6 moles of oxygen atoms, and 0.01 to 0.05 moles of nitrogen atoms, based on one mole of the transition metal. In this case, the transition metal, and the carbon, oxygen, and nitrogen atoms may be derived from the MXenes included in the MXene fibers (I) and the low-molecular-weight binder including the functional group.

Particularly, because a change in weight of the transition metal includes in the MXene fibers (I) and the MXene fibers (II) is not caused during the heat treatment, changes in compositions of the MXene fibers (I) and MXene fibers (II) may be explained based on the atomic concentration of the transition metal. That is, the MXene fibers (II) may include carbon atoms reduced by 50 to 98%, specifically 70 to 95%, oxygen atoms reduced by 30 to 70%, specifically 40 to 60%, and nitrogen atoms reduced by 70 to 99%, specifically 85 to 95% relative to the MXene fibers (I), based on the atomic concentration of the transition metal.

That is, because the carbon, the nitrogen, and the oxygen-functional group present in the inside and surfaces of the MXene fibers (I) are removed by means of the heat treatment, the MXene fibers (II) according to one aspect of the present invention may be induced into fibers having a more compact structure, and may have further improved mechanical characteristics, electrical characteristics, and stability.

Specifically, according to one aspect of the present invention, the MXene fibers may satisfy the following Expression 1 before and after the heat treatment:

$$\frac{{D}_{1}}{{D}_{0}} < 1.0 \qquad [ Expression 1 ]$$

wherein D₀ represents a d-spacing (nm) of (002) plane calculated from an X-ray diffraction pattern of the MXene fibers (I) before heat treatment using a Cu Kα radiation, and D₁ represents a d-spacing (nm) of (002) plane calculated from an X-ray diffraction pattern of the MXene fibers (II) after the heat treatment using a Cu Kα radiation.

Specifically, the value of Expression 1 may be less than 0.98, preferably may be in a range of 0.50 to 0.97. That is, the MXene fibers (II) according to the present invention may form a high-density fibrous phase in a denser and more compact manner because the low-molecular-weight binder including the functional group, and the oxygen-functional group present on surfaces of the MXene fibers (II) are removed through the heat treatment. In this case, more preferably, when the MXene fibers are heat-treated at 200 to 500° C., the MXene fibers may satisfy Expression 1.

Specifically, according to one aspect of the present invention, the MXene fibers (II) may have more improved electrical conductivity after the heat treatment. Specifically, the electrical conductivity of the MXene fibers (II) after the heat treatment may be greater than or equal to 1,050 S/cm, specifically in a range of 1,050 to 10,000 S/cm. Preferably, the MXene fibers (II) after the heat treatment may have an electrical conductivity of 1,150 to 8,000 S/cm, and most preferably an electrical conductivity of 3,000 to 6,000 S/cm. More specifically, the MXene fibers may satisfy the following Expression 2 before and after the heat treatment.

$$\frac{{σ}_{1}}{{σ}_{0}} \geq 2.0 \qquad [ Expression 2 ]$$

wherein σ₀ represents an electrical conductivity (S/cm) of the MXene fibers (I) before the heat treatment, and σ₁ represents an electrical conductivity (S/cm) of the MXene fibers (II) after the heat treatment.

Specifically, the value of Expression 2 may be in a range of 2.0 to 10.0, preferably in a range of 2.5 to 8.0, more preferably in a range of 3.0 to 8.0, and most preferably in a range of 3.5 to 6.0. The MXene fibers according to the present invention may form a high-density fibrous phase in a denser and more compact manner after the heat treatment, and thus may satisfy Expression 2. In this case, more preferably, when the MXene fibers (II) are heat-treated at 350 to 500° C., the MXene fibers (II) may satisfy Expression 2.

Specifically, according to one aspect of the present invention, the MXene fibers may satisfy the following Expression 3 before and after the heat treatment:

$$\frac{{TS}_{1}}{{TS}_{0}} \geq 1.2 \qquad [ Expression 3 ]$$

wherein TS₀ represents a tensile strength (MPa) of the MXene fibers (I) before the heat treatment, and TS₁ represents a tensile strength (MPa) of the MXene fibers (II) after the heat treatment.

Specifically, the value of Expression 3 may be in a range of 1.2 to 3.0, preferably in a range of 1.3 to 2.0, and more preferably in a range of 1.5 to 2.0. The MXene fibers according to the present invention may have excellent stability even when exposed to an outer humid atmosphere after the heat treatment, and thus may satisfy Expression 3 because it is possible to realize the excellent tensile strength of the MXene fibers capable of preventing damage to and a decrease in performance of the fiber. In this case, preferably, when the MXene fibers are heat-treated at 350 to 500° C., the MXene fibers may satisfy Expression 3.

The MXene thin films or MXene fibers according to the present invention may be applied to various fields requiring the excellent mechanical properties and electrical conductivity, and may, for example, be applied to the fields requiring various effects of the present invention, such as electrochemistry, electronics, fibers, aviation, militaries, automobiles, and the like.

Hereinafter, a method of manufacturing MXene fibers according to the present invention and MXene fibers manufactured therefrom will be described in further detail with reference to examples thereof. However, it should be understood that the present invention may be embodied in various forms, and that the following examples are illustrative only to describe the present invention in more detail, but are not intended to limit the scope of the present invention.

Also, unless otherwise defined, all of the technical and scientific terms used herein have the same meaning as commonly understood by one of ordinary skill in the art to which the present invention pertains. The terms used in the detailed description of this application are given only to effectively describe certain examples, but are not intended to limit the present invention.

Further, the units of additives which are not particularly described in this specification may be based on weight.

[Method of Property Measurement]

1. Tensile Strength

The MXene fibers manufactured in Examples were measured using a microforce testing machine (Instron 8848) instrument. Both ends of a fiber having a length (L₀) of 2 cm were fixed in a 5 N Load cell instrument using a pneumatic grip, and a force (N) applied to both ends of the fiber was measured while applying a tensile force with 2 mm/min speed. The force thus measured was divided by a cross-sectional area (A) of the fiber so that the force was converted into a tensile strength.

2. Electrical Conductivity

To measure the electrical conductivity of the MXene fibers of Examples, both ends of a 1 cm-long fiber were fixed with Silver paste, and resistance of the fiber was measured using a MODEL 1009 Multimeter instrument (commercially available from KYORITSU). Thereafter, a length and a cross-sectional area of the fiber were used to convert the measured resistance into an electrical conductivity (S/cm). The cross-sectional area was measured using a scanning electron microscope (SEM).

### Example 1

3 g of MAX powder serving as a precursor of MXenes was added to 4.8 g of lithium fluoride (LiF) and 60 mL of an aqueous solution of hydrochloric acid (HCl; a concentration of 9 M), and then reacted at 35° C. for 24 hours to chemically exfoliate the MAX powder, thereby manufacturing MXenes. The non-exfoliated MAX in the solution was removed by centrifugation at 3,500 rpm. The MXenes thus manufactured were centrifuged under conditions of 17,000 rpm and 30 minutes, and a supernatant was then removed to manufacture an aqueous dispersion of MXenes at a concentration of 15% by weight.

The aqueous dispersion of MXenes was wet-spun at 25° C. using a spinning spinneret (nozzle) having a round spinning nozzle diameter of 500 μm. In this case, the aqueous dispersion of MXenes was spun at 25° C. and a flow rate of 0.2 mL/min in a coagulation solution that was an aqueous solution of 0.1 M ethylenediamine. In this case, the winding speed was 1 m/min.

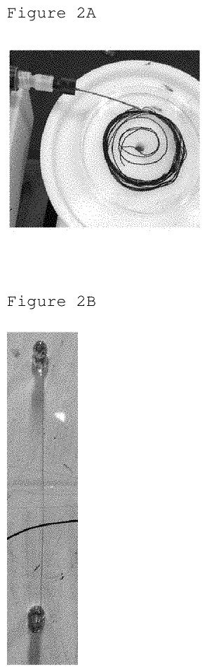

The spun fiber was washed with distilled water, and both ends of the fiber were then fixed as shown in FIGS. 2A-2B, and dried at room temperature for an hour in the air.

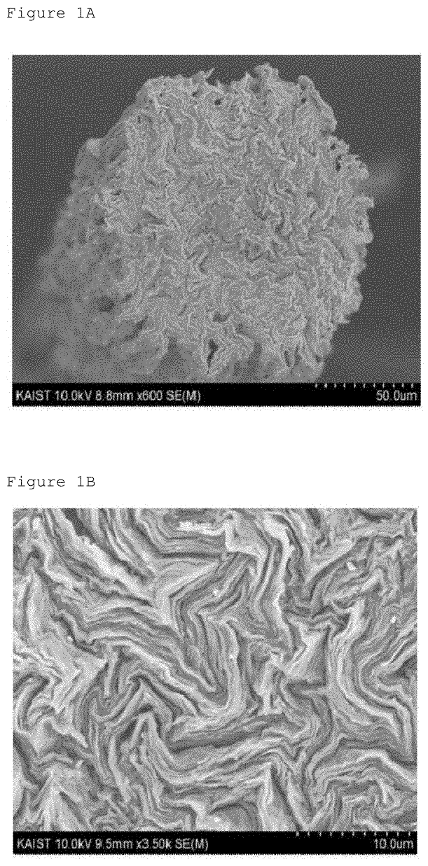

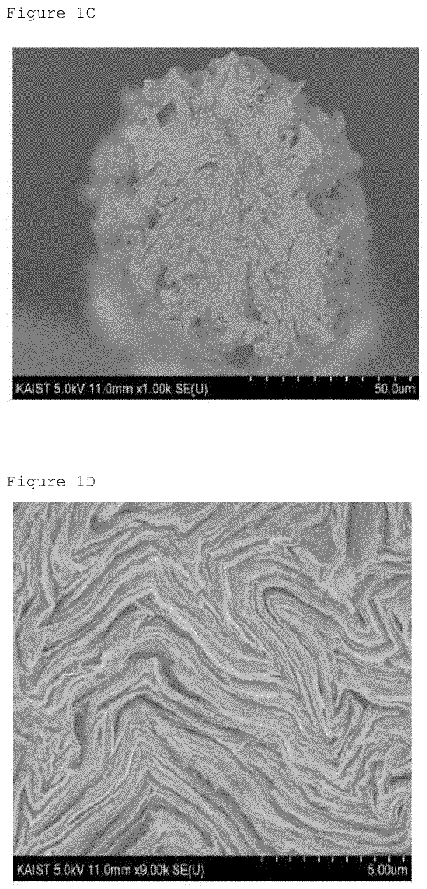

As shown in FIGS. 1A and 1B, it was confirmed, using a scanning electron microscope (SEM, Hitachi S-4800), that the dense high-density fiber was manufactured as the MXene fiber manufactured in Example 1. In this case, an average diameter of the MXene fibers was 140 μm.

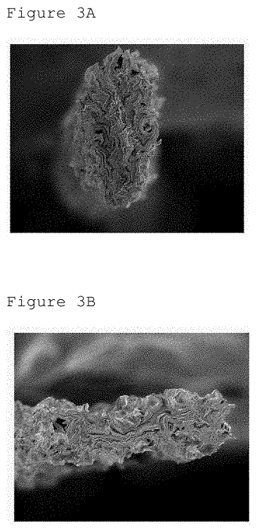

In addition, the MXene fiber of Example 1 was spun using a spinning nozzle with an oval or rectangular cross-sectional shape other than a spinning nozzle with a round cross-sectional shape. Thereafter, a cross-sectional shape of the MXene fiber was observed using a scanning electron microscope (SEM). As a result, as shown in FIGS. 3A-3B, when the MXene fibers were manufactured using (A) the spinning nozzle with the oval cross-sectional shape and (B) the spinning nozzle with the rectangular cross-sectional shape, the MXene fibers were successfully manufactured with oval and rectangular cross-sectional shapes, respectively. Also, it was confirmed that the manufactured MXene fibers were fibers having a very dense cross section, as seen from the cross-sectional shape of the scanning electron microscope.

### Example 2

A MXene fiber was manufactured in the same manner as in Example 1, except that a round spinning spinneret having a diameter of 250 μm was used. As shown in FIGS. 1C and 1D, it was confirmed, using a scanning electron microscope (SEM, Hitachi S-4800), that the dense high-density fiber was manufactured as the MXene fiber manufactured in Example 2. In this case, an average diameter of the MXene fibers was 65 μm.

### Example 3

A MXene fiber was manufactured in the same manner as in Example 1, except that the final MXene fiber obtained in Example 1 was heat-treated at 100° C. for an hour under an argon atmosphere.

### Example 4

A MXene fiber was manufactured in the same manner as in Example 1, except that the final MXene fiber obtained in Example 1 was heat-treated at 200° C. for an hour under an argon atmosphere.

### Example 5

A MXene fiber was manufactured in the same manner as in Example 1, except that the final MXene fiber obtained in Example 1 was heat-treated at 400° C. for an hour under an argon atmosphere.

### Example 6

A MXene fiber was manufactured in the same manner as in Example 1, except that an aqueous solution of 0.12 M ethanolamine was used as the coagulation solution.

### Example 7

A MXene fiber was manufactured in the same manner as in Example 1, except that an aqueous solution of 0.07 M polyethyleneimine (number average molecular weight: 600; Merck) was used as the coagulation solution.

### Example 8

A MXene fiber was manufactured in the same manner as in Example 1, except that an aqueous solution of 0.1 M 1,4-diaminobutane was used as the coagulation solution.

### Example 9

A MXene fiber was manufactured in the same manner as in Example 1, except that an aqueous solution of 0.2 M ethylenediamine was used at a flow rate of 0.1 mL/min.

### Example 10

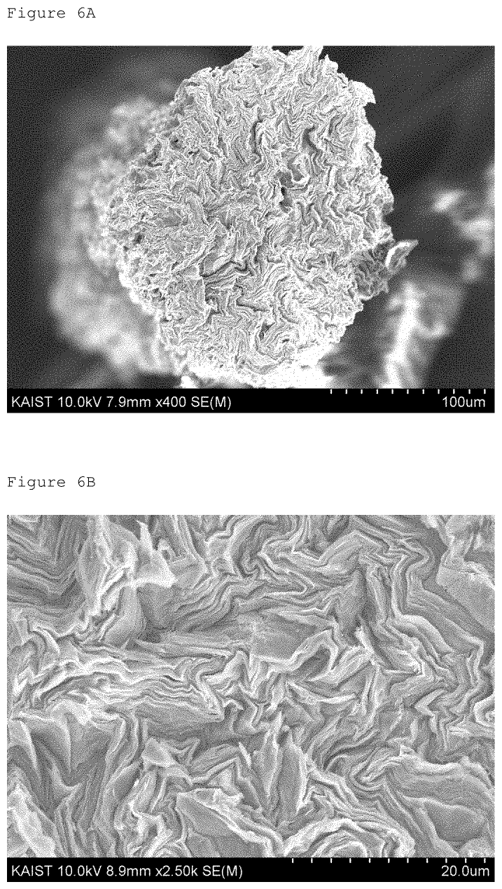

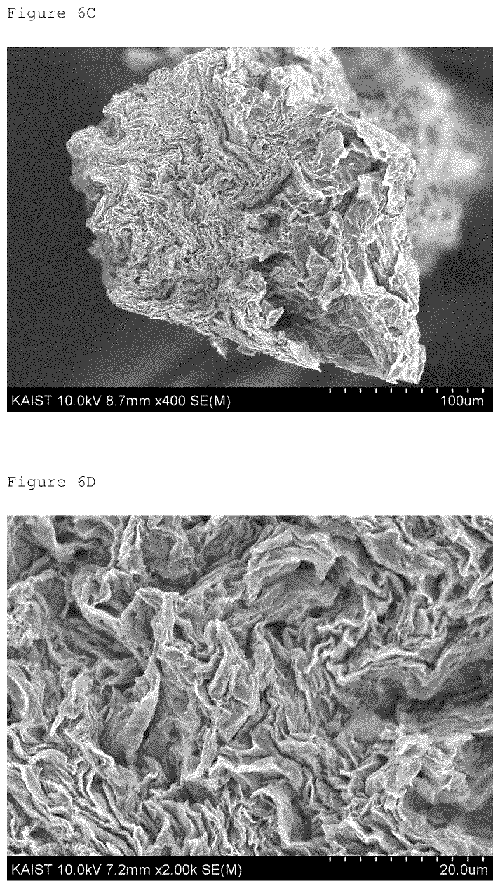

A MXene fiber was manufactured in the same manner as in Example 9, except that dopamine hydrochloride was added to the dispersion of Example 9 at a weight ratio of 1:0.05 (MXene: dopamine hydrochloride) and stirred for an hour. A cross-sectional shape of the MXene fiber was observed using a scanning electron microscope (SEM). As a result, as shown in FIGS. 6C and 6D, it was confirmed that a dense high-density fiber having a more pleated cross-sectional shape was manufactured, compared to that of Example 9 (FIGS. 6A and 6B).

### Comparative Example 1

A MXene fiber was manufactured in the same manner as in Example 1, except that a coagulation solution, which was obtained by mixing 5% by weight of calcium chloride (CaCl₂) in a solvent of distilled water and isopropanol (at a weight ratio of 3:1), was used as the coagulation solution. In this case, the manufactured MXene fiber was coagulated during the spinning, but broken during a drying process, which made it difficult to maintain a fiber shape.

### Comparative Example 2

A MXene fiber was manufactured in the same manner as in comparative Example 1, except that a mixed MXene/GO solution, which was obtained by further mixing graphene oxide (GO) with the aqueous dispersion of MXenes so that an amount of the graphene oxide (GO) was 5% by weight, was spun. In this case, the manufactured MXene fiber (not shown) was spun, but had a week mechanical strength, which made it impossible to wind the MXene fiber.

### Comparative Example 3

A MXene fiber was manufactured in the same manner as in Comparative Example 2, except that a coagulation solution, which was obtained by mixing 5% by weight of calcium chloride (CaCl₂)) in a solvent of distilled water and isopropanol (at a weight ratio of 3:1), was used as the coagulation solution. In this case, the manufactured MXene fiber (not shown) was spun, but had a week mechanical strength, which made it impossible to wind the MXene fiber.

### Experimental Example 1

Analysis of Shapes of MXene Fibers

As shown in FIG. 1, the cross sections of the MXene fibers manufactured in Examples 1 and 2 were observed using a scanning electron microscope. As shown, it can be seen that the cross sections of the MXene fibers had a structure in which MXene layer intervals were dense and compact, and the MXene fibers were manufactured with a high density.

### Experimental Example 2

Analysis of Compositions of MXene Fibers

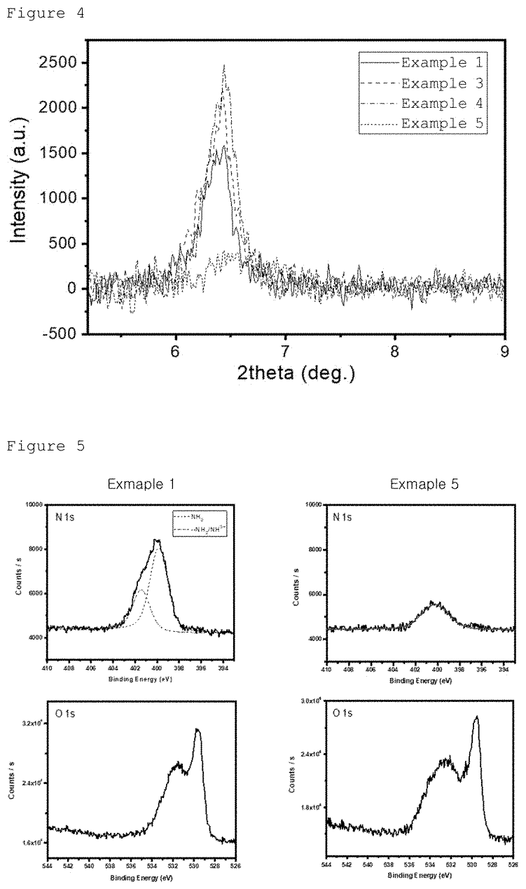

As shown in FIG. 4, the compositions of the MXene fibers manufactured in Example 1, Example 3 (at a heat treatment temperature of 100° C.), Example 4 (at a heat treatment temperature of 200° C.), and Example 5 (at a heat treatment temperature of 400° C.) were analyzed by X-ray diffraction analysis (XRD). As shown, it can be seen that the MXene fibers manufactured in Examples appeared to exhibit [002] diffraction peaks at less than 10°, and thus had a two-dimensional layered structure with/without the heat treatment. However, it can be seen that phase change into TiO₂ occurred as the heat treatment temperature increased, resulting in reduced intensities of the [002] diffraction peaks.

Table 1 lists the results of analyzing the d-spacings of the two-dimensional layered structures analyzed based on the XRD analysis results. As shown, it can be seen that the d-spacings decreased as the heat treatment temperature increased. These results are coincident with the results of Experimental Example 1.

TABLE 1

| | | d-Spacing |
|---|---|---|
| Items | (002) Peak | (nm) |
| Example 1 | 6.24 | 1.416 |
| Example 3 | 6.24 | 1.416 |
| Example 4 | 6.44 | 1.372 |
| Example 5 | 6.56 | 1.347 |

### Experimental Example 3

Analysis of Chemical Composition of MXene Fibers

The chemical composition of the MXene fiber manufactured in Example 1 and Example 5 (at a heat treatment temperature of 400° C.) were analyzed by X-ray photoelectron spectroscopy (XPS). The results are shown in FIG. 5 and listed in Table 2. Based on the concentration of titanium (Ti) atoms serving as the transition metal derived from the MXenes, it can be seen that the concentrations of the carbon (C), oxygen (O), and nitrogen (N) atoms derived from the ethylenediamine, which was a coagulation solution for MXene fibers, were reduced after heat treatment at 400° C.

TABLE 2

| | | | Element ratio based | |
|---|---|---|---|---|
| | Element (%) | | on Ti | |
| Items | Example 1 | Example 5 | Example 1 | Example 5 |
| Ti | 19.26 | 51.25 | 1 | 1 |
| C | 53.47 | 21.75 | 2.78 | 0.42 |
| O | 19.68 | 25.35 | 1.02 | 0.49 |
| N | 7.59 | 1.65 | 0.39 | 0.03 |

### Experimental Example 4

Measurement of Mechanical Properties and Electrical Conductivity of MXene Fibers

Tensile strengths and electrical conductivities of the MXene fibers manufactured in Examples were measured. The results are listed in Table 3 below.

TABLE 3

| | Tensile strength | Electrical conductivity |
|---|---|---|
| | (mpa) | (S/cm) |
| Example 1 | 88.6 | 985.40 |
| Example 2 | 65.8 | 1013.02 |
| Example 3 | 67.2 | 1219.39 |
| Example 4 | 85.9 | 1193.49 |
| Example 5 | 106.0 | 4165.90 |

As listed in Table 3, it can be seen that the dense high-density fibers were manufactured as the MXene fibers according to the present invention even when the dispersion composed only of the MXenes were spun, and had excellent tensile strength and electrical conductivity as well.

In particular, it was confirmed that the MXene fibers according to the present invention realized further improved tensile strength and electrical conductivity when the MXene fibers were subjected to heat treatment. Specifically, it can be seen that, when the MXene fibers were heat-treated at 350° C. or higher, the tensile strength and the electrical conductivity of the heat-treated MXene fibers were enhanced 1.6-fold and 4.11-fold higher than that of the MXene fibers before the heat treatment, respectively.

Accordingly, it can be seen that the MXene fibers according to the present invention realized significantly improved mechanical properties and electrical conductivity by spinning a dispersion, which does not include a heterogeneous material but includes MXenes, in a coagulation solution including a diamine-based compound.

The MXene fibers according to the present invention may realize excellent mechanical properties and electrical conductivity, and thus may be applied to various fields requiring the properties. For example, the MXene fibers according to the present invention may be applied to various fields such as electric lead wires, supercapacitors, wearable devices, and the like.

The method of manufacturing MXene fibers according to the present invention has an advantage in that MXenes having a weak interaction between layers may be fiberized using a dispersion including the MXenes.

Also, the MXene fibers according to the present invention have advantages in that the fibers can be uniformly and densely manufactured with a high density, and a cross-sectional shape of the fiber can be easily adjusted according to the shape of a spinning spinneret.

In addition, the MXene fibers according to the present invention have an advantage in that they have superior mechanical properties and electrical conductivity. Further, the MXene fibers according to the present invention have an advantage in that the mechanical properties and electrical conductivity of the MXene fibers can be significantly improved by further heat-treating the MXene fibers.

Hereinabove, although the method of manufacturing MXene fibers and the MXene fibers manufactured therefrom according to the present invention have been described with reference to the specific subject matters and limited embodiments thereof, they have been provided only for assisting in the entire understanding of the present invention. Therefore, the present invention is not limited to the exemplary embodiments. Various modifications and changes may be made from this description by those skilled in the art to which the present invention pertains.

Therefore, the spirit of the present invention should not be limited to the embodiments as described herein, and the following claims as well as all modifications equal or equivalent to the claims are intended to fall within the scope and spirit of the invention.

1. A method of manufacturing MXene fibers, comprising:
a) preparing a dispersion including MXenes; and
b) spinning the dispersion in a coagulation solution to obtain MXene fibers.

2. The method of claim 1, wherein the coagulation solution comprises a low-molecular-weight binder including a functional group.

3. The method of claim 2, wherein the MXene fibers are linked via any one or more attraction forces selected from electrostatic interaction and hydrophobic interaction as the low-molecular-weight binder including the functional group is inserted between MXene layers.

4. The method of claim 2, wherein the low-molecular-weight binder including the functional group is an amine-based compound or an imine-based compound.

5. (canceled)

6. The method of claim 1, further comprising, after the step b):
heat-treating the MXene fibers at 100 to 500° C.

7. The method of claim 1, wherein the dispersion comprises 5 to 30% by weight of the MXenes, based on the total weight of the dispersion.

8. The method of claim 1, wherein the dispersion further comprises a phenol-based amine.

9. The method of claim 8, wherein a weight ratio of the MXenes and the phenol-based amine included in the dispersion is in a range of 1:0.001 to 0.5.

10. MXene fibers having a round, oval, or flat cross-sectional shape.

11. The MXene fibers of claim 10, wherein the MXene fibers are linked via any one or more attraction forces selected from electrostatic interaction and hydrophobic interaction as a low-molecular-weight binder including a functional group is inserted between MXene layers.

12. The MXene fibers of claim 10, wherein the MXene fibers include 1.5 to 10 moles of carbon atoms, 0.5 to 4 moles of oxygen atoms, and 0.01 to 1 mole of nitrogen atoms, based on 1 mole of a transition metal derived from the MXenes.

13. The MXene fibers of claim 11, wherein the low-molecular-weight binder including the functional group is an amine-based compound or an imine-based compound.

14. The MXene fibers of claim 13, wherein the amine-based compound is an aliphatic diamine.

15. The MXene fibers of claim 11, wherein a weight ratio of the MXenes and the low-molecular-weight binder including the functional group included in the MXene fibers is in a range of 1:0.01 to 0.5.

16. The MXene fibers of claim 10, wherein the MXene fibers have an average diameter of 10 to 500 μm.

17. The MXene fibers of claim 10, which have an electrical conductivity of 800 S/cm or more.

18. The MXene fibers of claim 10, wherein the MXenes are complexed with polydopamine.

19. The MXene fibers of claim 18, wherein the polydopamine is obtained by polymerizing dopamine through an effect of charge transfer with the MXenes.

20. MXene fibers comprising 0.1 to 1 mole of carbon atoms, 0.1 to 1 mole of oxygen atoms, and 0.01 to 0.1 moles of nitrogen atoms based on one mole of a transition metal and having an electrical conductivity of 1,050 S/cm or more.

21. (canceled)

22. (canceled)

23. The MXene fibers of claim 20, wherein the MXene fibers satisfy the following Expression 1:
$$\frac{{D}_{1}}{{D}_{0}} < 1.0 \qquad [ Expression 1 ]$$
(wherein D₀ represents a d-spacing (nm) of (002) plane calculated from an X-ray diffraction pattern of the MXene fibers defined in claim 11 using a Cu Kα radiation, and D₁ represents a d-spacing (nm) of (002) plane calculated from an X-ray diffraction pattern of the MXene fibers which are manufactured by heat-treating the MXene fibers defined in claim 11 using a Cu Kα radiation).
